(19) United States
(12) Patent Application Publication
(10) Pub. No.: US 2012/0064431 A1
(43) Pub. Date: Mar. 15, 2012

(54) POLYMER ELECTROLYTE-CATALYST COMPOSITE STRUCTURE PARTICLE AND MANUFACTURING METHOD THEREOF, ELECTRODE, MEMBRANE ELECTRODE ASSEMBLY (MEA), AND ELECTROCHEMICAL DEVICE

(75) Inventors: Atsushi Sato, Kanagawa (JP); Kenji Kishimoto, Tokyo (JP); Azumi Nakamura, Kanagawa (JP)

(73) Assignee: SONY CORPORATION, Tokyo (JP)

(21) Appl. No.: 13/321,955

(22) PCT Filed: Jun. 4, 2010
(86) PCT No.: PCT/JP2010/059888

§ 371 Date: Nov. 22, 2011

(30) Foreign Application Priority Data
Jun. 4, 2009 (JP) 2009-134574

(51) Int. Cl. H01M 8/10; B05D 3/00; B05D 5/12

(52) U.S. Cl. 429/480; 429/492; 429/494; 429/483; 427/58

(57) ABSTRACT

Polymer electrolyte-catalyst particles that are effective in preventing agglomeration of catalyst particles and polymer electrolyte particles, effective in the formation of ion pathways by polymer electrolyte particles and electron pathways by catalyst particles, and that are able to realize strong catalytic performance by improving the use efficiency of the catalyst particles and a manufacturing method thereof, electrodes formed using such composite structure particles, a membrane electrode assembly (MEA), and an electrochemical device are provided.

First, the dispersion liquid in which an ion conducting polymer electrolyte material is dispersed and microparticles 1 are mixed, and the surfaces of the microparticles 1 are coated by an ion conducting polymer electrolyte layer 2 that does not contain a catalyst material. Next, catalyst particles 3 with electron conductivity are added and mixed into the dispersion liquid of after the above step, the catalyst particles 3 are arranged in contact with the polymer electrolyte layer 2, and polymer electrolyte-catalyst composite structure particles 4 are produced. A porous layer that contains the polymer electrolyte-catalyst composite structure particles 4 formed in contact with a power collector becomes an electrode with ion conductivity.

### TECHNICAL FIELD

The present invention relates to polymer electrolyte-catalyst composite structure particles and a manufacturing method thereof, and electrodes, a membrane electrode assembly (MEA), and an electrochemical device such as a fuel cell that are produced using the polymer electrolyte-catalyst composite structure particles.

### BACKGROUND ART

In recent years, with regard to mobile electronic apparatuses such as notebook personal computers and mobile phones, there has been a trend of increasing power consumption along with increasingly high functionality and multi-functionality. Fuel cells are attracting attention as a next generation of mobile electronic apparatus power source that is able to accommodate such trends. In a fuel cell, fuel is supplied to a negative electrode (anode) and the fuel is oxidized, air or oxygen is supplied to a positive electrode (cathode) and the oxygen is reduced, and the fuel is oxidized by the oxygen in the fuel cell as a whole. At this time, the chemical energy stored in the fuel is efficiently converted into electric energy and is retrieved. A fuel cell has the characteristic, providing that it does not break down, of being able to be used continuously as a power supply by supplying fuel.

Various types of fuel cells have already been proposed or trialed, and some have been put into practical use. Fuel cells are categorized depending on the electrolytes used into alkaline electrolyte fuel cells, phosphoric acid fuel cells, molten carbonate fuel cells, solid oxide fuel cells, polymer electrolyte fuel cells (PEFC), and the like. Among the above, with a PEFC, since there is no concern of the electrolytes dispersing as solids, a PEFC is able to be operated at a lower temperature compared to other types of fuel cells, for example, at a temperature of approximately between 30° C. and 130° C., the startup time is short, and the like, the PEFC is preferable as a mobile power source.

FIG. 8 is a cross-sectional diagram that illustrates the structure of a fuel cell that is configured as a PEFC. In a fuel cell 10, an anode (fuel electrode) 12 and a cathode (oxygen electrode) 13 are respectively joined opposing each other and a membrane electrode assembly (MEA) 14 is formed on both side surfaces of a hydrogen ion (proton) conducting polymer electrolyte membrane 11 such as a perfluorosulfonic acid membrane. In the anode 12, a porous anode catalyst layer 12b that contains polymer electrolyte particles with hydrogen ion (proton) conductivity and catalyst particles with electron conductivity is formed and a gas diffusion electrode is formed on a surface of a gas permeable power collector (gas diffusion layer) 12a composed of a porous conductive material such as carbon sheet or carbon cross. Furthermore, similarly in the cathode 13, a porous cathode catalyst layer 13b that contains polymer electrolyte particles with hydrogen ion conductivity and catalyst particles with electron conductivity is formed and a gas diffusion electrode is formed on a surface of a gas permeable power collector 13a composed of a porous support such as carbon sheet. The catalyst particles may be particles composed solely from catalyst materials or may be composite particles in which the catalyst material is supported by a carrier.

The membrane electrode assembly (MEA) 14 is held between a fuel flow path 21 and an oxygen (air) flow path 24, and is included in the fuel cell 10. When generating power, on the anode 12 side, fuel is supplied from a fuel introduction opening 22 and discharged from a fuel discharge opening 23. During this time, a portion of the fuel passes through the gas permeable power collector (gas diffusion layer) 12a and reaches the anode catalyst layer 12b. Various combustible materials such as hydrogen or methanol are able to be used as the fuel of the fuel cell. On the cathode 13 side, oxygen or air is supplied from an oxygen (air) introduction opening 25 and discharged from an oxygen (air) discharge opening 26. During this time, a portion of the oxygen (air) passes through the gas permeable power collector 13a and reaches the cathode catalyst layer 13b.

For example, in a case when the fuel is hydrogen, the hydrogen supplied to the anode catalyst layer 12b is oxidized over the anode catalyst particles by a reaction shown in Reaction Formula (1) below

2H₂→4H⁺+4e⁻ (1)

and electrons are provided to the anode 12. The generated hydrogen ions H⁺ pass through the polymer electrolyte membrane 11 and move to the cathode 13 side. The oxygen that is supplied to the cathode catalyst layer 13b reacts over the cathode catalyst particles with the hydrogen ions that have moved from the anode side by a reaction shown in Reaction Formula (2) below

O₂+4H⁺+4e⁻→2H₂O (2)

and is reduced, and electrons are taken out from the cathode 13. In the fuel cell 10 as a whole, a reaction shown by Reaction Formula (3) below that combines Reaction Formulae (1) and (2) takes place.

2H₂+O₂2H₂O (3)

Since gaseous fuels such as hydrogen require a high-pressure container for storage or the like, gaseous fuels are not suited to miniaturization. On the other hand, although liquid fuels such as methanol have the advantage of being easy to store, since the configuration of a fuel cell of a type that retrieves hydrogen from liquid fuel by a reformer becomes complicated, such a fuel cell is not suited to miniaturization. In contrast, a direct methanol fuel cell (DMFC) that reacts methanol by supplying directly to the anode without reforming has a characteristic of easily storing the fuel while having a simple configuration and being easy to miniaturize. In the past, DMFCs have often been combined with PEFCs and have been researched as a type of PEFC, and hold the greatest promise as a mobile electronic apparatus power source.

However, the output density of a DMFC, that is, the output by unit mass or unit volume of a battery is presently insufficient. Further, since catalysts such as platinum are expensive and are rare resources, it is desirable to reduce the usage amount thereof as much as possible. Therefore, in order to put DMFCs into practical use, there is a need to improve output density while suppressing the usage amount of catalysts such as platinum to as little as possible.

Here, that the catalyst amount that is actually involved in an electrode reaction is small, that is, the use efficiency of the catalyst particles is low compared to the catalyst amount that is contained in the catalyst layer has been identified as one reason that is preventing an improvement in output density and a reduction in the catalyst amount in PEFCs such as a DMFC (for example, the use efficiency of catalyst particles is approximately 10%. Refer to Edson A. Ticianelli, J. Electroanal. Chem., 251, 275 (1998).).

FIG. 9(a) is an outline diagram that enlarges and illustrates the structure of the cathode catalyst layer 13b and the vicinity thereof that is equivalent to the region illustrated by being surrounded with a dotted line in FIG. 8, in order to examine the reason behind the low use efficiency of catalyst particles (below, although only the cathode catalyst layer 13b is examined in order to simplify description, the anode catalyst layer 12b is the same.). As described above, in the cathode 13, the porous cathode catalyst layer 13b that contains polymer electrolyte particles 51 with hydrogen ion conductivity and catalyst particles 52 with electron conductivity is formed on a surface of the gas permeable power collector 13a composed of carbon sheet or the like, and the cathode catalyst layer 13b is joined to the hydrogen ion conducting polymer electrolyte membrane 11.

In the reactions shown in Reaction Formulae (1) and (2) described above, since gas molecules, hydrogen ions, and electrons are involved, a region in which the three types of particles are able to gather together is necessary as a space for the reactions to take place (such a region is known as a three-phase interface). In the cathode catalyst layer 13b described above, the polymer electrolyte particles 51 have hydrogen ion conductivity, the catalyst particles 52 have electron conductivity, and movement of the gas particles is possible through vacancies 53 that are present in the layer.

Therefore, regions that are points of contact between, or in the vicinities of, the polymer electrolyte particles 51 and the catalyst particles 52, and that face the vacancies 53 are three-phase interfaces. However, in order for the three-phase interfaces to function effectively, there is a need for the hydrogen ions to be smoothly supplied from the polymer electrolyte membrane 11 to the three-phase interfaces and for the electrons to be supplied smoothly from the gas permeable power collector 13a to the three-phase interfaces.

It can be seen from the above that in order to improve the use efficiency of the catalyst particles 52, it is necessary to consider the distribution state of the polymer electrolyte particles 51 and the catalyst particles 52 in the cathode catalyst layer 13b by paying attention not only to the positional relationship of the polymer electrolyte particles 51, the catalyst particles 52, and the vacancies 53 that form the three-phase interfaces, but also to the positional relationship of each of the polymer electrolyte particles 51 that form hydrogen ion pathways and the positional relationship of each of the catalyst particles 52 that form electron pathways.

The example illustrated in FIG. 9(a-1) is an example in which the three-phase interfaces are formed effectively. In the example, the polymer electrolyte particles 51 and the catalyst particles 52 are appropriately dispersed and a large number of contact points are formed between the polymer electrolyte particles 51 and the catalyst particles 52, out of which the contact points facing the vacancies 53 or the vicinities thereof are the three-phase interfaces. Moreover, since each of the polymer electrode particles 51 are in contact with one another, the hydrogen ions are able to be smoothly transferred from the polymer electrolyte membrane 11 to the three-phase interfaces as shown by the arrows. Further, since each of the catalyst particles 52 are in contact with one another, the electrons are able to be smoothly transferred from the gas permeable power collector 13a to the three-phase interfaces as shown by the arrows. As a result, the three-phase interfaces function effectively, and the catalytic performance of the catalyst particles 2 is realized effectively.

On the other hand, the examples illustrated in FIGS. 9(a-2) and 9(a-3) are examples in which the three-phase interfaces are not formed effectively, and examples in which the three-phase interfaces do not function effectively.

The example illustrated in FIG. 9(a-2) is an example in which the composition amount of the catalyst particles 52 is too small compared to the composition amount of the polymer electrolyte particles 51, and the catalyst particles 52 are too evenly dispersed. In such a case, although contact points with the polymer electrolyte particles 51 are formed efficiently in the vicinity of the catalyst particles 52, the catalyst particles 52 are surrounded by the polymer electrolyte particles 51, buried in the polymer electrolyte particle 51 layer, and not able to face the vacancies 53, and thus the three-phase interfaces are not easy to form. Even if the three-phase interfaces are formed, since the catalyst particles 52 are isolated, electrons are not easily transferred from the gas permeable power collector 13a to the three-phase interfaces. The three-phase interfaces therefore do not function effectively, and the catalytic performance of the catalyst particles 52 is not realized effectively.

Although not shown in the drawings, in a case when the composition amount of the polymer electrolyte particles 51 is too small compared to the composition amount of the catalyst particles 52, since there are not enough polymer electrolyte particles 51 in the vicinity of the catalyst particles 52 and the contact points with the polymer electrolyte particles 51 are not efficiently formed, the three-phase interfaces are not easy to form. Even if the three-phase interfaces are formed, since the hydrogen ion pathways by the polymer electrolyte particles 51 are not sufficiently formed, the three-phase interfaces do not function effectively, and the catalytic performance of the catalyst particles 52 are not realized effectively.

From the above, it can be considered that there is a preferable range of composition ratio between the composition amount of the polymer electrolyte particles 51 and the catalyst particles 52. For example, an example of such a composition ratio is shown in PTL 1 described later.

The example illustrated in FIG. 9(a-3) is an example in which the dispersion of the catalyst particles 52 is insufficient and one or both of the catalyst particles 52 and the polymer electrolyte particles 51 are agglomerated with one another in a lump form. In such a case, since the contact points between the polymer electrolyte particles 51 and the catalyst particles 52 are considerably reduced, the number of three-phase interfaces that are formed is considerably reduced. Further, since the hydrogen ion pathways by the polymer electrolyte particles 51 and the electron pathways by the catalyst particles 52 are not sufficiently formed, the three-phase interfaces do not function effectively, and the catalytic performance of the catalyst particles 52 are not realized effectively.

Natural agglomeration of microparticles occurs invariably, and is not easily suppressed. Furthermore, the smaller the particle size of the catalyst particles 52 and the polymer electrolyte particles 51 is made to be in order to cause the catalyst particles 52 and the polymer electrolyte particles 51 to function effectively, the greater the agglomeration force thereof. It is therefore extremely difficult to handle microparticles while maintaining the dispersion state of the microparticles and to realize high functionality of the microparticles. Particularly with fuel cells, when the catalyst layer becomes dry, agglomeration of the polymer electrolyte particles 51 and the catalyst particles 52 tends to worsen, uneven natural agglomeration takes place, and portions that do not contribute to the electrode reactions tend to appear.

As examined above, in order to improve the use efficiency of the catalyst particles 52, there is first a need to set the ratio between the composition amount of the polymer electrolyte particles 51 and the composition amount of the catalyst particles 52 appropriately. There is moreover a need for a scheme to prevent the agglomeration of the polymer electrolyte particles 51 and the catalyst particles 52. At this time, it is not sufficient to merely mix the polymer electrolyte particles 51 and the catalyst particles 52 evenly, but there is a need to structure the distribution of the polymer electrolyte particles 51 and the distribution of the catalyst particles 52 by forming the hydrogen ion pathways such that each of the polymer electrolyte particles 51 are connected to one another, and by forming the electron pathways such that each of the catalyst particles 52 are connected to one another. It is not possible to expect a distribution state that is structured in such a manner to be formed naturally by the simple method of mixing the polymer electrolyte particles 51 and the catalyst particles 52 in a dispersion medium and applying the obtained dispersion liquid on the gas permeable power collector 13a of the related art.

FIG. 9(b) is an outline diagram that illustrates the structure of the cathode catalyst layer 13b on which microparticles 54 are added (however, in FIG. 9(b), the polymer electrolyte particles 51 are not shown so that the drawing is easier to see). In the past, in order to improve the water retentivity and moisture adjustability of the catalyst layer and to prevent excessive wetting or drying of the catalyst layer, a configuration in which silica microparticles or the like are added to the catalyst layer of the anode or the cathode has been suggested (for example, refer to Japanese Unexamined Patent Application Publication No. 2002-289200).

Even in such a case, the circumstances described above do not change fundamentally by merely adding the microparticles 54. That is, in a case when the catalyst particles 52 are too evenly distributed as illustrated in FIG. 9(b-2) or in a case when the dispersion of the catalyst particles 52 is insufficient and one or both of the catalyst particles 52 and the polymer electrolyte particles 51 are agglomerated with one another in a lump form as illustrated in FIG. 9(b-3), effective three-phase interfaces are not easily formed. Further, the structured distribution state of the catalyst particles 52 as illustrated in FIG. 9(b-1) is not naturally formed by a method of the related art of mixing and applying the polymer electrolyte particles 51, the catalyst particles 52, and the microparticles 54.

Therefore, in PTL 2 described later, a conductive composite material that is merged with a conductive porous base material including: a conductive porous base material; a precious metal catalyst that is supported on the conductive porous base material and that forms a conductive porous catalyst base material along with the conductive porous base material; and moisture adjusting particles that are coated by hydrogen ion (proton) conducting polymers, wherein the moisture adjusting particles that are coated by the hydrogen ion conducting polymers are injected into vacancies of the conductive porous catalyst base material is suggested.

FIG. 10(a) is an outline diagram that illustrates the structure of the conductive composite material used as a catalyst layer as shown in PTL 2. A catalyst layer 113 forms, similarly to the catalyst layer 12b and 13b illustrated in FIG. 9, a gas diffusion electrode along with a gas permeable power collector (gas diffusion layer) 112, and has one surface that is in contact with a hydrogen ion (proton) conducting polymer electrolyte membrane 111.

The catalyst layer 113 is configured by carbon particles 101 that support a platinum catalyst and silica particles 102 that are coated by Nafion (registered trademark of E.I. DuPont de Nemours and Company). A layer of platinum supporting carbon molecules 101 is equivalent to the conductive porous catalyst base material, a layer of carbon particles 101a is equivalent to the conductive porous base material, and platinum particles 101b are equivalent to the precious metal catalysts. Further, Nafion®-coated silica particles 102 are equivalent to the coated moisture adjusting particles, silica particles 102a are equivalent to the moisture adjusting particles, and Nafion® 102b is equivalent to the hydrogen ion (proton) conducting polymer. As the conductive porous base material, other than the carbon particle layer, graphite or porous metals are exemplified.

In such a manner, the special characteristic of the conductive composite material is that moisture adjusting particles that are coated by the polymers are injected and formed on the vacancies that the conductive catalyst base material includes. For this reason, the average particle diameter of the moisture adjusting particles that are coated by the hydrogen ion conducting polymer needs to be smaller than the size of the vacancies. In the example of the catalyst layer 113 illustrated in FIG. 10(a), the Nafion®-coated silica particles 102 are injected into gaps that are formed in the layer made of the platinum supporting carbon particles 101. In PTL 2, it is stated that uniform moisture adjustability is provided to the catalyst layer 113 by adopting such a manufacturing method.

In addition, as an improvement on the structure of the catalyst particles on a microscopic scale such that the three-phase interfaces are efficiently formed, a fuel cell that is characterized by being a polymer electrolyte-catalyst complex that includes polymer electrolytes, catalytic materials, and carbon particles and in which the catalytic materials are selectively formed on contact surfaces between proton conduction paths of the polymer electrolytes and the carbon particles is proposed in PTL 3 described later.

FIG. 10(b) is a cross-sectional diagram that illustrates the structure of the polymer electrolyte-catalyst complex 200 shown in PTL 3. In the complex 200, a portion or the entirety of the surface of carbon particles 201 is coated by hydrogen ion (proton) conducting polymers 202. Further, catalyst particles 205 are selectively arranged on hydrogen ion (proton) conduction paths 203 that are coated by an acidic group of the polymer 202. There are few catalyst particles 206, which are not effective as catalysts, which are arranged in a region of the polymers 202 which is covered by a frame unit 204 that has no hydrogen ion (proton) conductivity. It is therefore stated in PTL 3 that the use efficiency of the catalyst particles in the complex 200 is remarkably high.

In order to produce the polymer electrolyte-catalyst complex 200, using a cation exchange resin as the hydrogen ion conducting polymer 202, a step of producing a mixture of the cation exchange resin and carbon particles, a step of causing cations that include catalytic metallic elements to be adsorbed on the cation exchange resin by an ion exchange reaction of cations that include counterions of the cation exchange resin and the catalytic metallic element, and a step of chemically reducing the cations that include the catalytic metallic elements that are adsorbed on the cation exchange resin to generate the catalyst particles 205 are performed.

### CITATION LIST

### Patent Literature

PTL 1: Japanese Unexamined Patent Application Publication No. 2001-319661 (claim 1, pages 4 and 5, paragraphs 0035 to 0038, FIG. 11)
PTL 2: International Publication No. WO2008-030198 (claim 1, pages 10 to 13, paragraphs 0042 to 0044 and 0048, FIG. 9)
PTL 3: Japanese Unexamined Patent Application Publication No. 2000-12041 (claims 1, 5, and 10, pages 3 to 5, FIG. 2)

### SUMMARY OF INVENTION

### Technical Problem

As described using FIG. 9, in order to improve the use efficiency of the catalyst particles 52, a scheme to prevent the agglomeration of the catalyst particles 52 and the polymer electrolyte particles 51 is necessary. At this time, it is not sufficient to merely mix the polymer electrolyte particles 51 and the catalyst particles 52 evenly, but there is a need to structure the distribution state of the polymer electrolyte particles 51 and the catalyst particles 52 by forming the hydrogen ion pathways such that each of the polymer electrolyte particles 51 are connected to one another, and by forming the electron pathways such that each of the catalyst particles 52 are connected to one another.

An example of the preferable composition ratio between the composition amount of the polymer electrolyte particles 51 and the composition amount of the catalyst particles 52 is shown in PTL 1. However, in PTL 1, a method of applying a dispersion liquid obtained by simply mixing the polymer electrolyte particles 51 and the catalyst particles 52 in a dispersion medium is used, and it is not possible to expect a distribution state that is structured as described above.

The conductive composite material proposed in PTL 2 is characterized by moisture adjusting particles coated by a hydrogen ion conducting polymer being injected and formed in vacancies included on a conductive porous catalyst base material. In other words, in such a composite material, the hydrogen ion conducting polymer is only introduced to positions where there are vacancies. On the other hand, numerous catalysts are arranged in positions other than where there are vacancies. Therefore, such numerous catalysts are not able to be in contact with the hydrogen ion conducting polymers and the catalytic performance is not able to be demonstrated. Moreover, it is unlikely that the hydrogen ion conducting polymers that are injected in the vacancies connect to one another and efficiently form pathways that transfer hydrogen ions. Therefore, it is considered that the use efficiency of the catalyst of the conductive composite material proposed in PTL 2 is low.

In the polymer electrolyte-catalyst complex 200 proposed in PTL 3, the catalyst particles 205 are selectively arranged on the contact surfaces of the polymer electrolyte proton conduction paths 203 and the carbon particles 201, and there is a possibility of greatly improving the use efficiency of the catalyst particles 205. However, since what is used in the formation of three-phase interfaces are the surfaces of the carbon particles 201, if the particle diameter of the carbon particles 201 is large, wasted volume increases and the density of the three-phase interfaces decreases. Therefore, in order to form the three-phase interfaces at a high density and to realize strong catalytic performance, there is a need to miniaturize the carbon particles 201.

However, as evidenced by FIG. 10(b), the composition ratio of the carbon particles 201 is very high in the complex 200. Therefore, in a case when the carbon particles 201 are miniaturized, it is difficult to cause cations including catalytic metallic elements to reliably adsorb onto the proton conduction paths 203 while preventing the agglomeration of the carbon particles 201 with one another. That said, if the composition ratio of the polymer electrolytes is increased in order to prevent the agglomeration of the carbon particles 201, since numerous proton conduction paths that are not in contact with the surfaces of the carbon particles 201 are formed and cations including catalytic metallic elements are adsorbed thereon, numerous isolated catalyst particles that are not supported on the surfaces of the carbon particles 201 are formed, and the use efficiency of the catalytic metallic elements decreases. Therefore, in order to realize strong catalytic performance with the complex 200, it is considered that a measure of some sort to prevent the agglomeration of the carbon particles 201 with one another is necessary. Further, in the polymer electrolyte-catalyst complex 200, since the catalyst particles 205 are formed from cations that include catalytic metallic elements in a state of being adsorbed on a cation exchange resin, there is a problem in which the types or the sizes of the catalyst particles 205 that are formed is limited, or a problem in which the number of production steps increases.

The invention is intended to solve the problems described above, and an object thereof is to provide polymer electrolyte-catalyst particles that are effective in preventing agglomeration of catalyst particles and polymer electrolyte particles, effective in the formation of ion pathways by polymer electrolyte particles and electron pathways by catalyst particles, and that are able to realize strong catalytic performance by improving the use efficiency of the catalyst particles, a manufacturing method thereof, electrodes formed using such composite structure particles, a membrane electrode assembly (MEA), and an electrochemical device.

### Solution to Problem

That is, the present invention relates to polymer electrolyte-catalyst composite structure particles including: microparticles; an ion conducting polymer electrolyte-containing layer that coats a portion or the entirety of a surface of the microparticles and which does not contain a catalyst material; and catalyst particles with electron conductivity that are arranged in contact with the polymer electrolyte-containing layer.

Furthermore, the invention relates to a manufacturing method of a polymer electrolyte-catalyst composite structure particles including: a first step of mixing a dispersion liquid in which an ion conducting polymer electrolyte material is dispersed and a powder of microparticles or a dispersion liquid thereof, and coating a portion or the entirety of the surfaces of the microparticles with an ion conducting polymer electrolyte-containing layer that does not contain a catalyst material; a second step of adding and mixing a powder of catalyst particles with electron conductivity or a dispersion liquid thereof to a dispersion liquid obtained in the first step, and arranging the catalyst particles to be in contact with the polymer electrolyte-containing layer.

In addition, the invention relates to a membrane electrode assembly (MEA) including: a first electrode; a second electrode; and an ion conducting electrolyte membrane that is interposed between the first electrode and the second electrode, wherein at least one of the first electrode and the second electrode is an electrode that includes a power collector and a porous catalyst layer with ion conductivity that is formed in contact with the power collector and which contains polymer electrolyte-catalyst composite particles according to any one of claims 1 to 8, and further relates to an electrochemical device including a first electrode, a second electrode, and an ion conductor that is interposed between the first electrode and the second electrode, wherein the ion conductor is configured to conduct ions from the first electrode to the second electrode and at least one of the first electrode and the second electrode is an electrode that includes a power collector and a porous catalyst layer with ion conductivity that is formed in contact with the power collector and which contains polymer electrolyte-catalyst composite particles according to any one of claims 1 to 8.

### Advantageous Effects of Invention

According to the polymer electrolyte-catalyst composite structure particles of the present invention, as will be made clear by a cyclic voltammetry measurement of Embodiment 1 described later, the effective surface area of the catalyst that is involved in the electrochemical reaction per unit catalyst amount increases. That is, the use efficiency of the catalyst increases. As a result, the amount of catalyst that is used is able to be reduced.

Although it cannot be said that the structure of the polymer electrolyte-catalyst composite structure particles is completely clear, it is considered to be as follows. That is, as is clear from the manufacturing method thereof, in the polymer electrolyte-catalyst composite structure particles of the invention, an ion conducting polymer electrolyte-containing layer that does not include the catalyst material and the catalyst particles with electron conductivity are structured and arranged in what is a two-storey layer. Since the lower layer does not include the catalyst material, ion pathways by the ion conducting polymer electrolyte material are reliably formed with the greatest efficiency. Since the catalyst particles are not included in the lower layer and therefore are arranged concentrated in the upper layer, the density of the catalyst particles is greater compared to a case when the same amount is dispersed evenly, and electron pathways due to the connections between the catalyst particles to another are formed effectively.

Moreover, with the catalyst particles of the upper layer, most of the particles are arranged in contact with the ion conducting polymer electrolyte-containing layer of the lower layer. Since the contact points between the catalyst particles and the ion conducting polymer electrolyte-containing layer are arranged on the surfaces of the microparticles, the supply of reactants or the discharge of products is easy. For example, in a case when the surfaces of the microparticles face a gaseous phase, three-phase interfaces are formed on the contact points therebetween or the vicinities thereof. Moreover, since many of the contact points are connected to the ion pathways and the electron pathways, the catalytic performance of the catalyst particles is realized effectively.

At this time, the microparticles exhibit two functions. One is to make the structuring described above possible as the supports for the two-storey layer described above. The other is to suppress the generation of catalyst particles that are unable to exhibit catalytic action effectively due to being buried too deeply and the supply of reactants and the discharge of products being difficult, by limiting the regions in which the ion conducting polymer electrolyte material and the catalyst particles are distributed to the vicinities of the surfaces of the microparticles.

The manufacturing method of the polymer electrolyte-catalyst composite structure particles of the invention is a method that makes the easy manufacture of the polymer electrolyte-catalyst composite structure particles possible.

Since an electrode of the invention is formed in contact with a power collector, contains the polymer electrolyte-catalyst composite structure particles, and includes a porous catalyst layer with ion conductivity, the electrode has excellent ion conductivity and electron conductivity, and is able to realize the catalytic action of the catalyst particles effectively. At this time, the microparticles form gaps in the vicinities thereof, cause a layer that contains the polymer electrolyte-catalyst composite structure particles to become a porous layer, and function to make the supply of reactants and the discharge of products easy. Therefore, the polarization of the electrode reaction becomes small.

For example, in a case when the gaps are gaseous phases, since gas molecules move through the gaps, three-phase interfaces are formed effectively.

Since the membrane electrode assembly (MEA) and the electrochemical device of the invention include the electrodes, it is possible to cause electrode reactions efficiently.

### BRIEF DESCRIPTION OF DRAWINGS

FIG. 1 includes perspective diagrams and cross-sectional diagram that illustrate the structure of a polymer electrolyte-catalyst composite structure particle and the production steps thereof based on Embodiment 1 of the invention.

FIG. 2 is an outline diagram that illustrates the structure of a membrane electrode assembly (MEA) of a fuel cell based on Embodiment 2 of the invention.

FIG. 3 is a current-voltage curve (a) and a current-output density curve (b) of a fuel cell obtained in Applied Example 1 of the invention.

FIG. 4(a) is a graph that illustrates the result of a CV measurement of an electrolyte solution of an electrode obtained in Applied Example 1 of the invention and FIG. 4(b) is a graph that illustrates the result of a CV measurement of an electrode obtained in Comparative Example 1 of the invention.

FIG. 5 is a graph that compares and illustrates the current-voltage curve (a) and the current-output density curve (b) of the fuel cell obtained in Example 1 of the invention with the result of the fuel cell obtained in Applied Example 1 and Comparative Example 1.

FIG. 6 is a graph that illustrates the relationship between a particle diameter φ of spherical silica microparticles and the output of the fuel cell by an experiment of Applied Example 2 of the invention.

FIG. 7 is a graph that illustrates the relationship between an additive amount of the spherical silica microparticles and the output of the fuel cell by an experiment of Applied Example 3 of the invention.

FIG. 8 is a cross-sectional diagram that illustrates an example of the structure of a fuel cell configured as a PEFC.

FIG. 9 is an outline diagram that magnifies and illustrates the structure of a cathode catalyst layer of a fuel cell and the vicinity thereof.

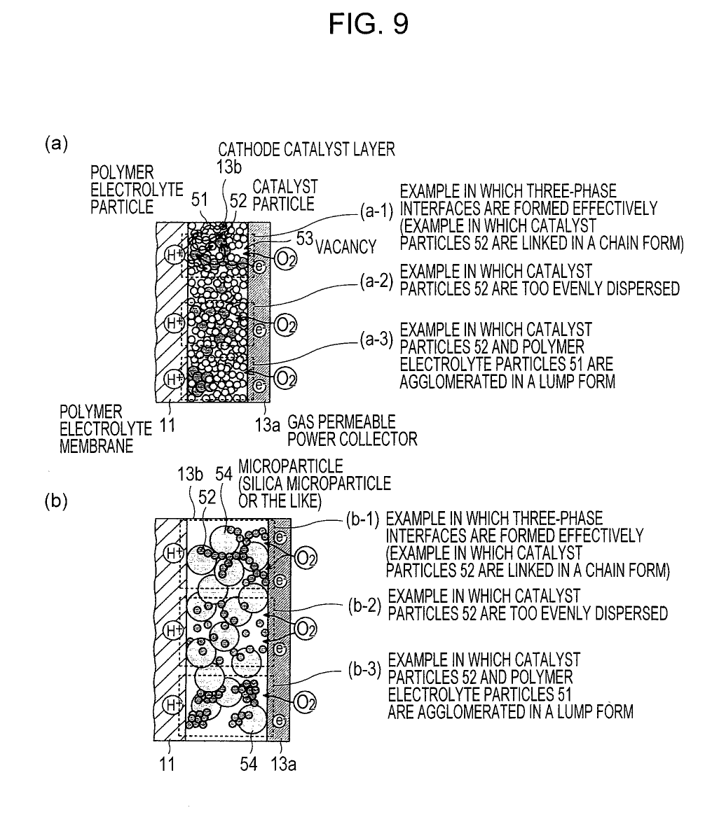

FIG. 10(a) is an outline diagram that illustrates the structure of a conductive composite material that is used as the catalyst layer as shown in PTL 2, and FIG. 10(b) is a cross-sectional diagram that illustrates the structure of a polymer electrolyte-catalyst complex as shown in PTL 3.

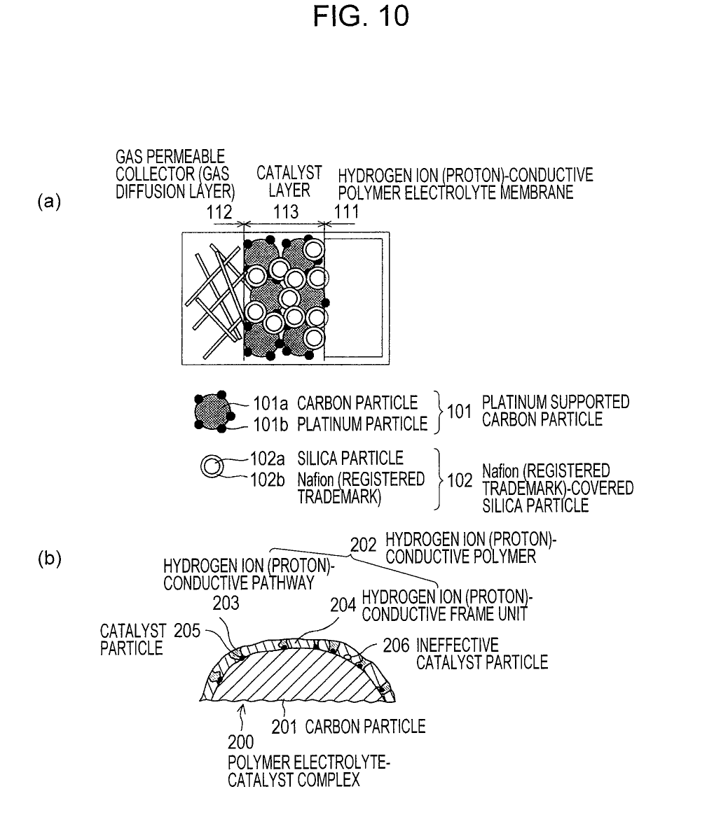

### DESCRIPTION OF EMBODIMENTS

With the polymer electrolyte-catalyst composite structure particles of the invention, it is desirable that the ion conducting polymer electrolyte-containing layer be a polymer electrolyte layer with hydrogen ion (proton) conductivity. At this time, it is desirable that the material of the polymer electrolyte layer with the hydrogen ion conductivity be a perfluorosulfonic acid-based resin.

Further, it is desirable that the material of the microparticles be an oxide of silicon or a metallic element, or a conductive carbon material.

Furthermore, it is desirable that the particle diameter φ of the microparticles be 10 nm≦φ≦1 μm.

In addition, it is desirable that the additive amount of the silicon oxide (silica) microparticles have a mass ratio to the catalyst mass of equal to or less than 0.40.

Furthermore, it is desirable that the catalyst particles with electron conductivity be metallic catalyst particles, or a metallic catalyst or a non-metallic catalyst that is supported by conductive supporting particles. For example, it is desirable that the catalyst particles with electron conductivity be not supported, or be a platinum catalyst or a platinum ruthenium alloy catalyst that is supported by conductive carbon particles. With the platinum catalyst or the platinum alloy catalyst supported by conductive carbon particles, since the whole of the catalyst has electron conductivity, electron pathways are easily formed, and moreover the catalytic performance is able to be strengthened by miniaturizing the platinum catalyst or the platinum alloy catalyst to the limits thereof. Furthermore, a two-element or multi-element metallic catalyst composed of a platinum alloy such as platinum molybdenum, platinum palladium, platinum titanium, platinum vanadium, platinum chromium, platinum manganese, platinum iron, platinum cobalt, or platinum nickel or non-metallic catalysts such as molybdenum oxide or an organic metallic complex are also effective.

It is desirable that the manufacturing method of the polymer electrolyte-catalyst composite structure particles of the invention include a step of causing a solvent to evaporate from the dispersion liquid containing the polymer electrolyte-catalyst composite structure particles obtained by the second step and solidifying the polymer electrolyte-catalyst composite structure particles.

It is desirable that an electrode of the invention be an electrode in which the power collector is gas permeable and the porous catalyst layer has hydrogen ion conductivity.

It is desirable that, in one or both of the membrane electrode assembly and the electrochemical device of the invention, the electrode be an electrode in which the power collector is gas permeable and the porous catalyst layer has hydrogen ion conductivity. It is desirable that such an electrochemical device is configured as a fuel cell.

Next, the preferable embodiments of the invention will be described specifically and in detail with reference to the drawings.

### Embodiment 1

In Embodiment 1, an example of the polymer electrolyte-catalyst composite structure particles according to claims 1 to 10 and the manufacturing method thereof will mainly be described.

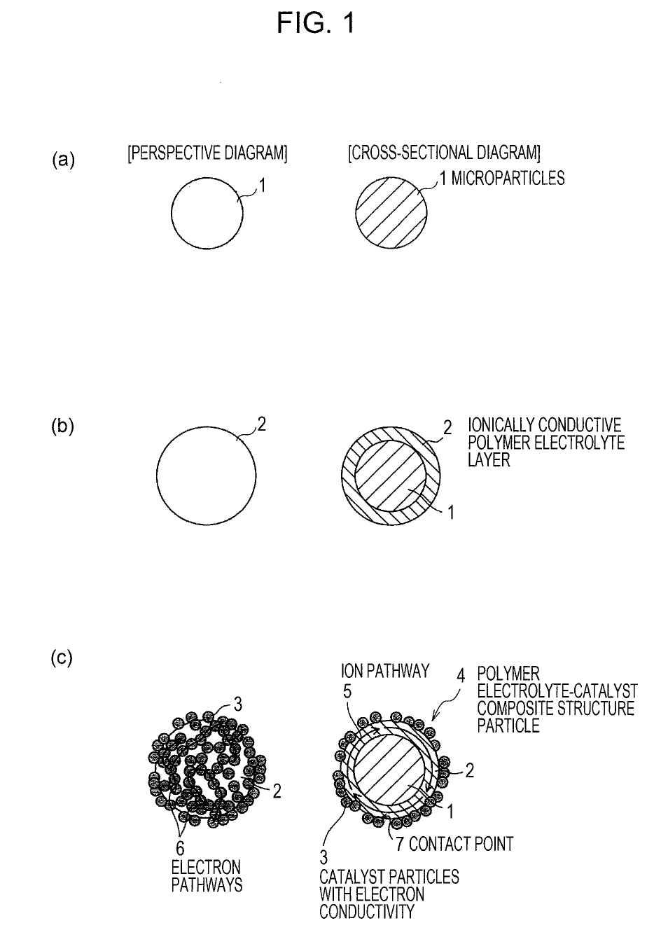

FIG. 1 is a perspective diagram and a cross-sectional diagram that illustrate the structure of a polymer electrolyte-catalyst composite structure particle and the flow of production steps thereof based on Embodiment 1 of the invention.

As illustrated in FIG. 1(c), with the polymer electrolyte-catalyst composite structure particles 4, a portion or the entirety of the surface of the microparticles 1 is coated by the ion conducting polymer electrolyte layer 2 that does not contain a catalyst material, and the catalyst particles 3 with electron conductivity are arranged in contact with the polymer electrolyte layer 2.

In order to produce the polymer electrolyte-catalyst composite structure particles 4, first, as a first step, a step of mixing a dispersion liquid in which an ion conducting polymer electrolyte material is dispersed in an appropriate solvent with a powder of the microparticles 1 or a dispersion liquid in which the microparticles 1 are dispersed in an appropriate solvent, and as illustrated in FIG. 1(b), coating the surfaces of the microparticles 1 with the ion conducting polymer electrolyte layer 2 that does not contain a catalyst material is performed. Thereafter, as a second step, a powder of the catalyst particles 3 with electron conductivity or the dispersion liquid in which the catalyst particles 3 are dispersed in an appropriate solvent is added and mixed with the dispersion liquid of after the first step, the catalyst particles 3 are deposited so as to be in contact with the polymer electrolyte layer 2, and the polymer electrolyte-catalyst composite structure particles 4 are generated.

As is clear from the manufacturing method thereof, with the polymer electrolyte-catalyst composite structure particles 4, the ion conducting polymer electrolyte layer 2 that does not contain a catalyst material and catalyst particles 3 with electron conductivity are structured and arranged in what is a two-storey layer on the surface of the microparticles 1. Since the ion conducting polymer electrolyte layer 2 of the lower layer does not include the catalyst material, ion pathways 5 by the ion conducting polymer electrolyte material are reliably formed with the greatest efficiency. Since the catalyst particles 3 are not included in the lower layer and therefore are arranged concentrated in the upper layer, the density of the catalyst particles 3 is greater compared to a case when the same amount is dispersed evenly. As a result, electron pathways 6 due to the connections between the catalyst particles 3 to one another are formed effectively.

Moreover, with the catalyst particles 3 of the upper layer, most of the particles are arranged in contact with the ion conducting polymer electrolyte layer 2 of the lower layer. Since contact points 7 between the catalyst particles 3 and the ion conducting polymer electrolyte layer 2 are arranged on the surfaces of the polymer electrolyte-catalyst composite structure particles 4, the supply of reactants or the discharge of products is easy. For example, in a case when the surfaces of the polymer electrolyte-catalyst composite structure particles 4 face a gaseous phase, three-phase interfaces are formed on the contact points 7 or in the vicinities thereof. Since many of the contact points 7 are connected to the ion pathways 5 or the electron pathways 6, the catalytic action of the catalyst particles 3 is realized effectively. Here, although not shown in the drawings, since the polymer electrolyte material that is deposited on the upper layer is also present rather than all of the surface of the polymer electrolyte layer 2 of the lower layer being covered by the catalyst particles 3, the polymer electrolyte material is exposed on portions of the surfaces of the polymer electrolyte-catalyst composite structure particles 4.

It is desirable that the manufacturing method of the polymer electrolyte-catalyst composite structure particles 4 include a step of causing a solvent to evaporate from the dispersion liquid containing the polymer electrolyte-catalyst composite structure particles 4 obtained by the second step and solidifying the polymer electrolyte-catalyst composite structure particles. By such a step, each of the ion conducting polymers are bound by intermolecular forces, a complex structure that is composed of the microparticles 1, the ion conducting polymers, and the catalyst particles 3 are thereby integrally fixed irreversibly, and the structures of the polymer electrolyte-catalyst composite structure particles 4 as composite structures are stabilized.

The microparticles 1 exhibit two functions. One is to function as the supports for the two-storey layer described above and to make the structuring of the distributions of the ion conducting polymer electrolyte material and the catalyst particles 3 possible. The other is to suppress the generation of catalyst particles that are unable to exhibit catalytic action effectively due to being buried too deeply and the supply of reactants and the discharge of products being difficult, by limiting the regions in which the ion conducting polymer electrolyte material and the catalyst particles 3 are distributed to the vicinities of the surfaces of the microparticles 1.

Although not particularly limited, the ion conducting polymer electrolyte layer 2 is, for example, a polymer electrolyte layer with hydrogen ion conductivity. In such a case, a polymer resin including sulfonic acid group-SO₃H is able to be used as the material of the hydrogen ion conducting polymer electrolyte layer. In particular, a perfluorosulfonic acid-based resin such as Nafion® is chemically stable and preferable.

The material of the microparticles 1 is not particularly limited either, and may be an inorganic material such as a silicon oxide such as silica, a conductive carbon material, a metal, or a metal oxide, or may be an inorganic material such as a polymer resin. The shapes of the microparticles 1 are not particularly limited either, and include defined shapes such as spherical shapes and columnar shapes, and undefined shapes that do not have defined shapes. For example, spherical silica microparticles are preferable since microparticles that are inexpensive to produce industrially and which have even particle diameters are able to be obtained. Further, microparticles made of a conductive carbon material are suited for cases when it is necessary for the microparticles to be conductive and to be chemically stable.

In a case when a polymer resin with a sulfonic acid group is used as the material of the ion conducting polymer electrolyte layer 2, it is preferable that the surfaces of the microparticles 1 be hydrophilic. This is because if the surfaces of the microparticles 1 are hydrophilic, affinity with the sulfonic acid group is good, and it becomes easier for the polymer electrolyte layer 2 to stick to the surfaces of the microparticles 1. For example, in a case when the microparticles 1 are silica microparticles, it is desirable that numerous silanol group-Si—OH molecules be formed on the surfaces of the silica microparticles.

It is desirable that the microparticles 3 with electron conductivity be metallic catalyst particles, or a metallic catalyst or a non-metallic catalyst that is supported by the conductive supporting particles. For example, it is desirable that the catalyst particles 3 be not supported or be platinum catalysts or platinum ruthenium alloy catalysts that are supported by conductive carbon particles such as carbon black. With a catalyst that is supported by conductive carbon particles, since the entireties of the catalyst particles have electron conductivity, electron pathways are formed easily, and it is moreover possible to strengthen the catalytic performance by miniaturizing the platinum particles or platinum alloy particles to the limits thereof. Furthermore, two-element or multi-element metallic catalysts composed of a platinum alloy such as platinum molybdenum, platinum palladium, platinum titanium, platinum vanadium, platinum chromium, platinum manganese, platinum iron, platinum cobalt, or platinum nickel or non-metallic catalysts such as molybdenum oxide or an organic metallic complex are also effective.

### EMBODIMENT 2

In Embodiment 2, an application example to a fuel cell with the electrode, the membrane electrode assembly (MEA), and the electrochemical device according to claims 10 to 16 as an example will mainly be described.

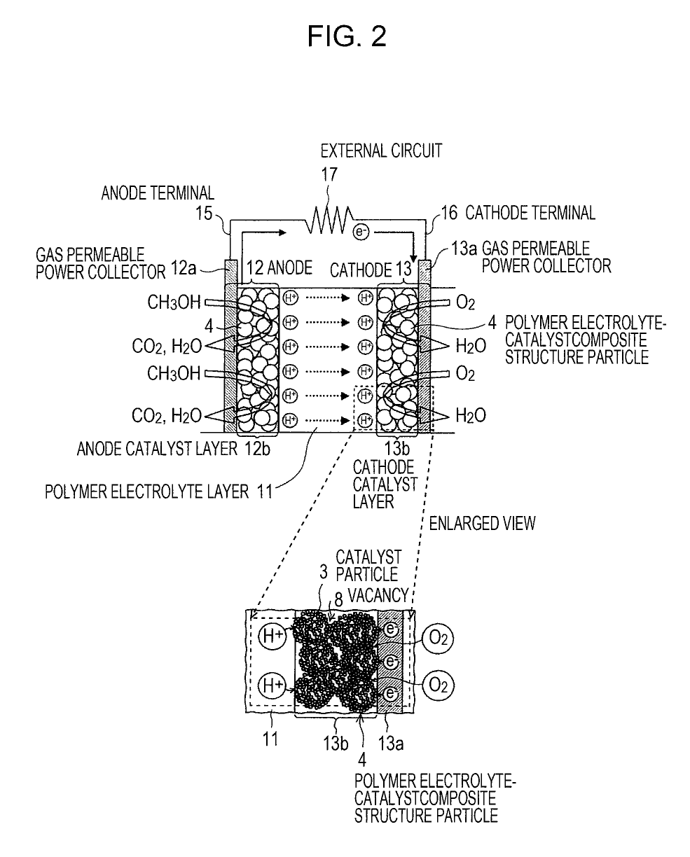

FIG. 2 is an outline diagram that illustrates the structure of a membrane electrode assembly (MEA) 14 that is the main part of a fuel cell based on Embodiment 2. With the MEA 14, the anode (fuel electrode) 12 and the cathode (oxygen electrode) 13 are respectively joined and formed opposing each other on the surfaces of both sides of the hydrogen ion (proton) conducting polymer electrolyte layer 11 such as a perfluorosulfonic acid-based resin membrane.

On the anode 12, a porous layer that contains the polymer electrolyte-catalyst composite structure particles 4 described in Embodiment 1 is formed as the anode catalyst layer 12b on the surface of the gas permeable power collector (gas diffusion layer) 12a that is composed of a porous conductive material such as carbon sheet or carbon cross, and a gas diffusion electrode is formed. Further, on the cathode 13, similarly, a porous layer that contains the polymer electrolyte-catalyst composite structure particles 4 is formed as the cathode catalyst layer 13b on the surface of the gas permeable power collector (gas diffusion layer) 13a that is composed of a porous conductive material such as carbon sheet, and a gas diffusion electrode is formed. The ion conducting polymer electrolyte layer 2 is a polymer electrolyte layer with hydrogen ion conductivity.

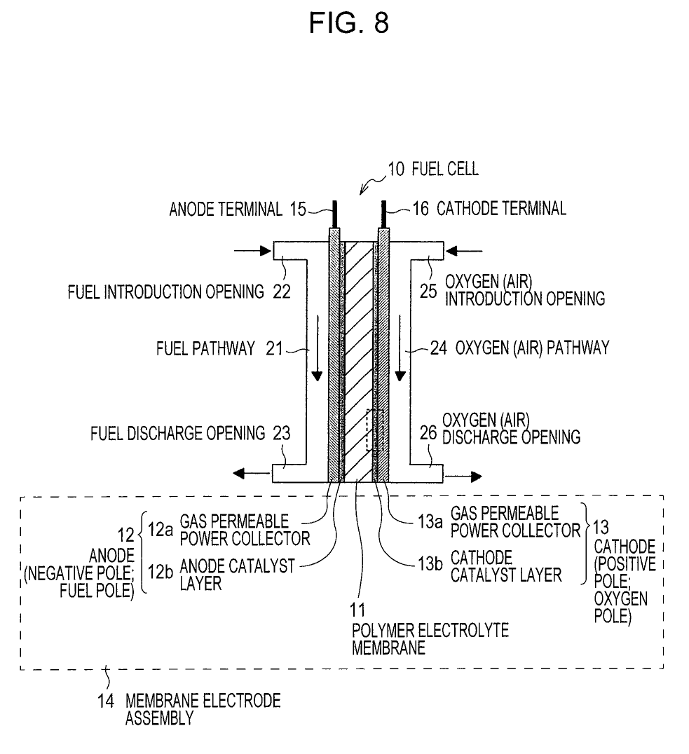

As illustrated using FIG. 8, the membrane electrode assembly (MEA) 14 is interposed between the fuel flow path 21 and the oxygen (air) flow path 24, and is built into the fuel cell 10. When electric power is being generated, on the anode 12 side, fuel such as hydrogen is supplied from the fuel introduction opening 22 and is discharged from the fuel discharge opening 23. During this time, a portion of the fuel moves through the gas permeable power collector (gas diffusion layer) 12a and reaches the anode catalyst layer 12b. Various flammable substances such as hydrogen or methanol are able to be used as the fuel of the fuel cell. On the cathode 13 side, oxygen or air is supplied from the oxygen (air) introduction opening 25 and is discharged from the oxygen (air) discharge opening 26. During this time, a portion of the oxygen (air) moves through the gas permeable power collector (gas diffusion layer) 13a and reaches the cathode catalyst layer 13b.

For example, in a case when the fuel cell is a direct methanol fuel cell (DMFC), the methanol that is the fuel is usually supplied as an aqueous solution of a low concentration or a high concentration, and evaporated methanol particles reach the anode catalyst layer 12b. The methanol particles supplied to the anode catalyst layer 12b are oxidized by a reaction shown by Reaction Formula (4) below

CH₃OH+H₂O→CO₂+6H⁺+6e⁻ (4)

over the anode catalyst particles, and provides electrons to the anode 12. The generated hydrogen ions H⁺ move to the cathode 13 side through the polymer electrolyte membrane 11. The oxygen supplied to the cathode catalyst layer 13b reacts with the hydrogen ions that arrive from the anode side by the reaction shown in Reaction Formula (5) below

(3/2)O₂+6H⁺+6e⁻→3H₂O (5)

over the cathode catalyst particles, is reduced, and takes in the electrons from the cathode 13. In the fuel cell 10 as a whole, a reaction shown below by Reaction Formula (6) in which Reaction Formulae (4) and (5) are added takes place.

CH₃OH+(3/2)O₂→CO₂+2H₂O (6)

As illustrated in FIG. 2 and the enlarged diagram in the lower portion thereof, a porous layer is formed on the anode catalyst layer 12b and the cathode catalyst layer 13b by the polymer electrolyte-catalyst composite structure particles 4 being adjacent to one another. As a result, out of the two layers that are above and below that coat the microparticles 1, the catalyst particles 3 that account for the upper layer are in contact with one another between the polymer electrolyte-catalyst composite structure particles 4, and electron pathways are formed all over the entirety of the catalyst layer. Further, the polymers of the hydrogen ion conducting polymer electrolyte layer 2 that account for the lower layer are also coupled with one another between the polymer electrolyte-catalyst composite structure particles 4 through the polymer electrolyte that is exposed on portions of the surfaces of the polymer electrolyte-catalyst composite structure particles 4, and hydrogen ion pathways are formed all over the entirety of the catalyst layer. Moreover, the polymer electrolyte-catalyst composite structure particles 4 make the catalyst layer porous by forming the vacancies 8 or gaps in the vicinities thereof. Since the supply of reactants or the discharge of products is performed easily through such vacancies 8 or gaps, polarization of the electrode reaction becomes small.

For example, as in the fuel cell 10, in a case when the vacancies 8 or the gaps are a gaseous phase, since gas molecules move through the vacancies 8 or the gaps, three-phase interfaces are efficiently formed on the contact points 7 between the catalyst particles 3 and the ion conducting polymer electrolyte layer 2 or in the vicinities thereof. Moreover, as previously mentioned, since many of the contact points 7 are connected to the ion pathways 5 or the electron pathways 6, the catalytic action of the catalyst particles 3 is realized effectively.

Here, it has been noted that if the microparticles are added to the catalyst layer with a configuration other than forming the polymer electrolyte-catalyst composite structure particles 4, the characteristics of the fuel cell deteriorate drastically. Further, although there are many patent applications that add a porous material such as silica in order to improve the water retentivity or the moisture adjustability of the catalyst layer and to prevent excessive dampening or drying of the catalyst layer, the presence or absence of a moisture adjusting function is irrelevant to the present invention. Furthermore, although there are many patent applications that seek to disperse catalysts into the inner surfaces of pores of porous materials such as silica, the presence or absence of micropores on the surfaces of the microparticles 1 is irrelevant to the invention.

### APPLIED EXAMPLES

Hereinbelow, the present invention will be described in more detail based on applied examples. In the applied examples, first, the polymer electrolyte-catalyst composite structure particles 4 described in Embodiment 1 were produced. Next, the electrodes, the membrane electrode assembly (MEA), and the fuel cell described in Embodiment 2 were produced using the polymer electrolyte-catalyst composite structure particles 4, and the electrochemical properties thereof were investigated. However, needless to say, the invention is not limited to the applied examples below.

### APPLIED EXAMPLE 1

### Production of Polymer Electrolyte-Catalyst Composite Structure Particles 4

Spherical silica microparticles for which microparticles with even particle diameters are inexpensively industrially obtainable were used as the microparticles 1. Further, Nafion® was used as the material of the hydrogen ion conducting polymer electrolyte layer 2. Furthermore, in the anode 12, a platinum ruthenium alloy catalyst (E-TEK, Pt:Ru=2:1) composed of platinum Pt and ruthenium Ru were used as the catalyst particles 3. The particle diameters of the catalyst particles are approximately 3 to 5 nm. Further, in the cathode 13, a platinum catalyst (Tanaka Kikinzoku Kogyo K.K., platinum supporting amount 70%) supported by the conductive carbon particles were used as the catalyst particles 3.

First, as the first step, a spherical silica dispersion liquid (Nissan Chemical Industries, Ltd., silica content rate 40 mass %) in which spherical silica microparticles 1 with an average particle diameter of 200 nm (standard deviation ±30 nm) are dispersed in water was measured such that the ratio of the silica mass to the catalyst mass was 0.07 and mixed with a Nafion® dispersion aqueous solution (product name DE-1021; E.I. DuPont de Nemours and Company), agitated overnight, and the surfaces of the spherical silica microparticles 1 were coated with a Nafion® layer 2.

Next, as the second step, a predetermined amount of the catalyst particles 3 in powder form were added and mixed into the dispersion liquid described above and dispersed evenly, the catalyst particles 3 were deposited in contact with the Nafion® layer 2, and the polymer electrolyte-catalyst composite structure particles 4 in which the spherical silica microparticles 1 are coated on two layers by the Nafion® layer 2 and the catalyst particles 3 were generated.

Next, the dispersion liquid obtained in the second step was moved to a flat vessel, the solvent was evaporated, and the polymer electrolyte-catalyst composite structure particles 4 were solidified. The obtained solids were scraped off and pulverized in a mortar, and the polymer electrolyte-catalyst composite structure particles 4 in powder form were obtained. By such a solidifying step, the structures of the polymer electrolyte-catalyst composite structure particles 4 as composite structures are stabilized. That is, if the solvent is evaporated and lost, each of the Nafion® particles are bound to one another by intermolecular forces. Since the Nafion® particles are polymers, even if the solvent is added once again, the Nafion® particles that are bound once do not easily separate and disperse in the solvent. As a result, the complex structure composed of the silica microparticles 1, the Nafion® particles, and the catalyst particles 3 are integrally fixed irreversibly and stabilized.

From the rate of decrease in mass by a thermogravimetric measurement, it can be estimated that the mass fraction of the Nafion® layer 2 out of the polymer electrolyte-catalyst composite structure particles 4 is approximately 30 to 40 mass %. If the approximate density of silica, Nafion®, and platinum ruthenium alloy is respectively 2.6 g/cm³, 0.85 g/cm³, and 21/cm³ and the average values of the thicknesses of the Nafion® layer 2 and the layer of the catalyst particles 3 are estimated based on the mass data described above and the particle diameter 200 nm of the silica microparticles 1, 175 to 220 nm and 5.5 to 7 nm are respectively obtained. From the calculation result, it was found that, with the polymer electrolyte-catalyst composite structure particles 4 obtained in Applied Example 1, a catalyst layer with an average of approximately one or two catalyst particles 3 is laminated over the Nafion® layer 2 in the thickness direction is laminated.

### <Production of Electrodes, Membrane Electrode Assembly (MEA), and Fuel Cell>

The anode 12 was produced as follows. That is, first, the polymer electrolyte-catalyst composite structure particles 4 in powder form described above produced using the platinum ruthenium alloy catalyst were mixed with ion exchange water and evenly dispersed, and a paste-form coating fluid was prepared. Next, a gas diffusion electrode was produced by evaporating the solvent and forming the porous catalyst layer 12b after applying the coating fluid over carbon paper (product name TPG-H-090, Toray Industries, Inc.) that is the gas permeable power collector 12a such that the catalyst supported amount is approximately 20 mg/cm². The gas diffusion electrode was cut into a square of 10 mm×10 mm as the anode 12.

The cathode 13 was produced using platinum catalyst supporting conductive carbon microparticles instead of a platinum ruthenium alloy catalyst. Further, the catalyst supporting amount over carbon paper was approximately 10 mg/cm². Otherwise, the cathode 13 was produced similarly to the anode 12.

As the hydrogen ion conducting polymer electrolyte membrane 11, a Nafion membrane 112 (product name; E.I. DuPont de Nemours and Company) of a thickness of 25 μm was cut into a square of 14 mm×14 mm. The membrane electrode assembly (MEA) 14 in which the entire surfaces of the anode 12 and the cathode 13 are opposing each other with the hydrogen ion conducting polymer electrolyte membrane 11 interposed therebetween was produced by interposing and thermocompressing the square hydrogen ion conducting polymer electrolyte membrane 11 between the anode 12 and the cathode 13 for 15 minutes under the conditions of a temperature of 130° C. and a pressure of 0.15 kN/cm². The fuel cell 10 was produced by inserting the membrane electrode assembly 14, after attaching the anode terminal 15 and the cathode terminal 16 thereto, between the fuel flow path 21 and the oxygen (air) flow path 24.

### Comparative Example 1

Electrodes, a membrane electrode assembly (MEA), and a fuel cell that do not contain the silica microparticles 1 are produced by the same steps as Applied Example 1. That is, the same amount of the Nafion® dispersion liquid and the catalyst particles 3 as in Applied Example 1 were mixed and evenly dispersed. Thereafter, the dispersion liquid was moved to a flat vessel and the solvent was evaporated and dried. A polymer electrolyte-catalyst complex in powder form was obtained by scraping off the dried solids and pulverizing in a mortar. The electrodes, the membrane electrode assembly (MEA), and the fuel cell were likewise produced thereafter similarly to Applied Example 1. The only difference with Applied Example 1 is that the step of mixing the silica dispersion liquid and the Nafion® dispersion liquid in advance was not performed, and other conditions such as quantities and operations are exactly the same as Applied Example 1.

Here, the catalyst supporting amount of the electrodes in Applied Example 1 is the added mass of the mass of the catalyst particles 3, the mass of the Nafion® layer 2, and the mass of the silica microparticles 1. On the other hand, the catalyst supporting amount of the electrodes in Comparative Example 1 is the added mass of the mass of the catalyst particles 3 and the mass of the Nafion®. Therefore, when electrodes are produced by the same catalyst supporting amount, the catalyst amount that is actually arranged on the electrodes in Applied Example 1 is smaller, compared to the catalyst amount that is arranged on the electrodes in Comparative Example 1, by the content amount of the silica microparticles 1.

### <Power Generation Performance of Fuel Cell>

By supplying 100% methanol as fuel from the fuel flow path 21 to the anode 12 and supplying air by natural aspiration from the oxygen (air) flow path 24 to the cathode 13, a power generation test of the fuel cell 10 as a cell was performed at a room temperature of 25° C.

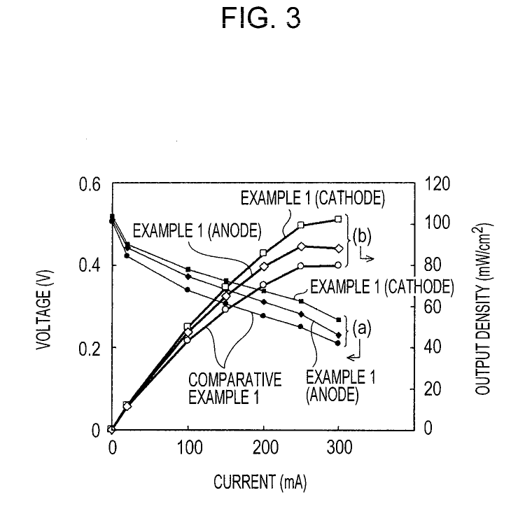

FIG. 3 is a current-voltage curve (a) and a current-output density curve (b) of a fuel cell obtained in Applied Example 1 and Comparative Example 1. It can be seen from FIG. 3 that the power generation performance improved whether the anode 12 or the cathode 13 obtained in Applied Example 1 is used. However, it was discovered that using the cathode 13 side exhibited a greater effect.

### <Cyclic Voltammetry (CV) Measurement of Electrodes>

In order to investigate the electrochemical characteristics of the produced electrodes, a cyclic voltammetry (CV) measurement of the membrane electrode assembly (MEA) 14 was performed. A bipolar cell was used for the measurement, with the working electrode as the cathode 13 and the reference electrode as the anode 12. The measurement was performed at room temperature.

The measurement of one cycle was changed in the order of approximately +0.075 V→approximately +1.000 V→+0.075 V such that the electric potential of the working electrode (cathode 13) against the electric potential of the reference electrode (anode 12) is first lowered to approximately +0.075 V to the reduction side, next raised to approximately +1.000 V to the oxidation side, and finally returned to +0.075 V. The speed with which the electric potential is controlled was 1 mV/s. At this time, hydrogen and nitrogen were respectively supplied to the anode 12 and the cathode 13 by the conditions below.

Anode 12 side: H₂ (15 mL/min, room temperature)

Cathode 13 side: N₂ (60 mL/min, humidified atmosphere, room temperature)
(Reference: Kim, J. H.; Ha, H. Y.; Oh, I. H.; Hong, S. A.; Kim, H. N.; Lee, H. I. Electrochimica Acta., 2004. 50. 801-806, “Fuel Cell Characterization Methods”, eds. Yoshio Takasu, Masaru Yoshitake, Tatsumi Ishihara, Kagaku Dojin)

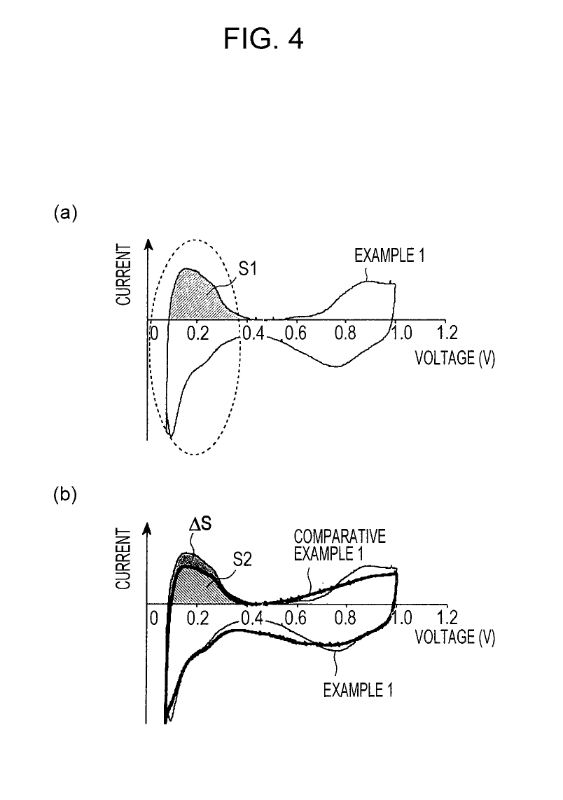

FIG. 4(a) is a graph that illustrates the result of the CV measurement of the electrode obtained in Applied Example 1. The horizontal axis is the electric potential of the working electrode (cathode 13) against the electric potential of the reference electrode (anode 12). FIG. 4(b) is a graph that compares and illustrates the result of a CV measurement of the electrodes obtained in Comparative Example 1 with the result of a CV measurement of the electrodes obtained in Applied Example 1.

With such CV measurements, absorption and desorption of hydrogen and redox reactions occur over the platinum catalyst inside the cathode 13 along with the sweeping of the electric potential of the working electrode (cathode 13). The absorption and desorption of hydrogen and redox reactions are measured since the CV current flows attached thereto. Inert gases such as nitrogen are passed through the cathode 13 side so that chemical species such as oxygen that cause a redox reaction by the catalytic action of platinum are removed. If such chemical species are present within the cathode 13, currents that are attached to the redox reactions of such chemical species are also measured as CV currents, and it is not possible to correctly measure only the CV currents that are attached to the adsorption and desorption process of hydrogen over the platinum catalyst.

By the measurement described above, catalytic performance that directly relates to the power generation performance of the fuel cell or the like in a state in which electrodes and a membrane electrode assembly (MEA) that are the actual usage forms as members of an electrochemical device, which is not able to be ascertained from a raw material of polymer electrolyte-catalyst composite structure particles 4 in powder form, is able to be evaluated. That is, it is possible to evaluate how much of the catalyst particles 3 are exposed on the surface and are effective after performing the steps up to the production of the electrodes and the membrane electrode assembly (MEA).

An effective surface area (ECSA; Electorochemcal Surface Aera) that is different from the physical surface area of each of the substances which is actually involved in the electrochemical reactions is calculated by compensating the difference in the catalyst amount described earlier from integral values S1 and S2 of the adsorption and absorption waves by the CV measurements of Applied Example 1 and Comparative Example 1 respectively illustrated in FIGS. 4(a) and 4(b). As a result, it was discovered that the effective surface area (ECSA) per unit mass of catalyst for the electrodes of Applied Example 1 is 1.5 times that of Comparative Example 1, whereby the catalyst is being used more effectively.

### APPLIED EXAMPLE 2

In Applied Example 2, the electrodes, the membrane electrode assembly, and the fuel cell were produced using the spherical silica microparticles 1 with a variety of average particle diameters φ with all but a change in the average particle diameter φ of the spherical silica microparticles 1 used the same as Applied Example 1, an experiment to investigate the effect that the particle diameter φ has on the power generation characteristics of a fuel cell was performed, and the preferable range of the particle diameters φ of the spherical silica microparticles 1 was investigated.

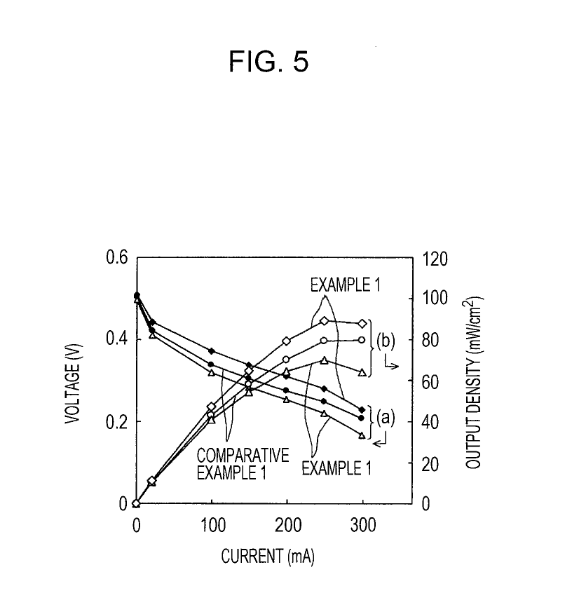

FIG. 5 is a graph that compares and illustrates the current-voltage curve (a) and the current-output density curve (b) of the fuel cell obtained in Example 1 in which an electrode obtained using the spherical silica microparticles 1 with an average particle diameter φ of 5 nm is the anode with the result of the fuel cell obtained in Applied Example 1 in which an electrode obtained using the spherical silica microparticles 1 with an average particle diameter φ of 200 nm is the anode and the result of the fuel cell obtained in Comparative Example 1. It can be seen from FIG. 5 that with Example 1 using the spherical silica microparticles 1 with an average particle diameter φ of 5 nm, the power generating characteristics of the fuel cell actually worsen.

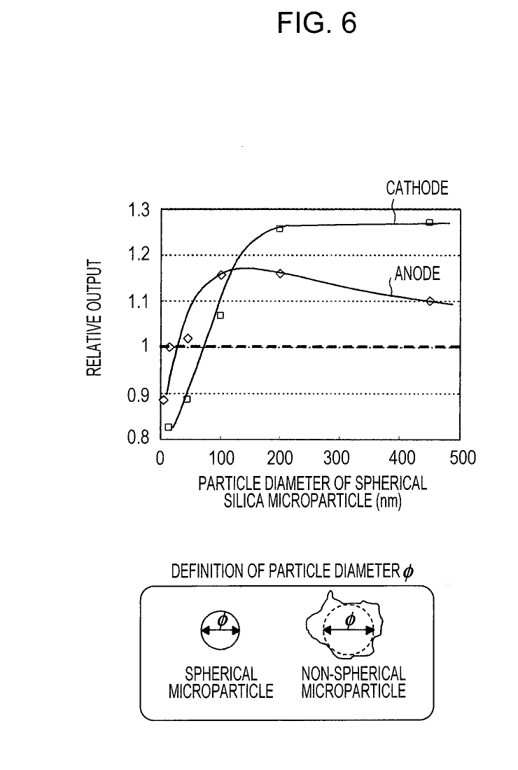

FIG. 6 is a graph that illustrates the relationship between the particle diameter φ of the spherical silica microparticles 1 and the output of the fuel cell by an experiment of Applied Example 2. The output is the value when the electric current value is 250 mA that approximately corresponds to the maximum output. As also illustrated in FIG. 3, there is a difference in the size of the addition effect of the spherical silica microparticles 1 between the anode and the cathode. Although such a difference is also seen in FIG. 6, if such a difference is excluded, it can be seen from FIG. 6 that the influence that the average particle diameter φ of the spherical silica microparticles 1 has over the output of the fuel cell has a common tendency between the anode and the cathode.

That is, as also illustrated in FIG. 5, with the addition of extremely small particles of less than an average particle diameter φ of 10 nm, the power generating characteristics decrease. It is considered that this is because, as seen in FIGS. 1 and 2, in a case when the particle diameters of the microparticles are equal to or less than approximately the same as the particle diameters of the particles that configure the ion conducting polymer electrolyte layer 2 or the catalyst microparticles 3, the microparticles do not exhibit, from the microparticles merely mixing with such particles, effects of structuring the distributions of the ion conducting polymer electrolyte particles or the catalyst microparticles 3 or turning the catalyst into a porous layer. If microparticles without such effects are added to the catalyst layer, since the sparseness of the distribution of the catalysts is related to the volume of the microparticles, the output of the fuel cell decreases.

On the other hand, also in a case when the particle diameter φ is too great, the power generating characteristics gradually decline as the particle diameter φ increases. It is considered that this is because with such spherical silica microparticles 1, although the effects of structuring the distributions of the ion conducting polymer electrolyte particles or the catalyst microparticles 3 or turning the catalyst layer into a porous layer is effective, as wasted volume (the volume taken up by the silica microparticles 1 where the catalyst microparticles 3 are not able to be arranged) increases as the particle diameter φ increases and the sparseness of the distribution of the catalysts is related to such a volume, the negative effect of the density of the three-phase interfaces decreasing becomes greater.

From the above, the effects of the silica microparticles are dependent on the particle diameter, and it is desirable that the particle diameter φ of the spherical silica microparticles 1 is 10 nm≦φ≦1 μm and further preferable as 50 nm≦φ≦500 nm (however, with regard to microparticles of forms other than spherical microparticles, as illustrated in the lower portion of FIG. 6, the diameter of the greatest sphere within the particle form is defined as the particle diameter φ).

Although the results described above are results obtained with regard to silica microparticles, it is considered from the working mechanisms thereof that microparticles in general share similar tendencies. Here, two or more types of microparticles with difference particle diameter sizes may be added by arbitrary proportions.

### Applied Example 3

In Applied Example 3, with all but the change in the additive amount of the spherical silica microparticles 1 the same as in Applied Example 1, electrodes, a membrane electrode assembly, and a fuel cell with a variety of different additive amounts of the spherical silica microparticles 1 with the average particle diameter φ were produced, an experiment to investigate the influence that the additive amount of the microparticles 1 has on the output of the fuel cell was performed, and the preferable range of the additive amount of the microparticles 1 was investigated.

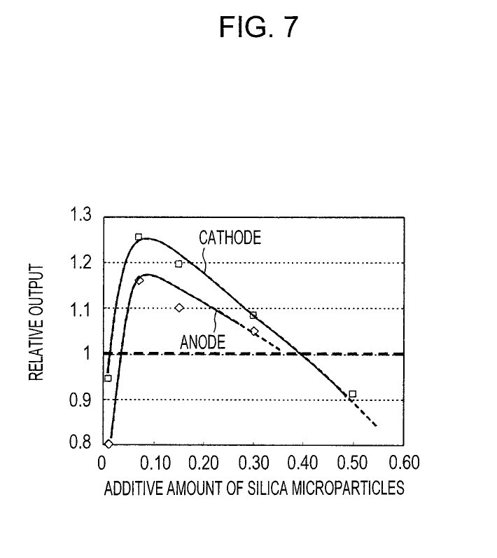

FIG. 7 is a graph that illustrates the relationship between an additive amount of the spherical silica microparticles 1 and the maximum output of the fuel cell by an experiment of Applied Example 3. However, the output is the value when the electric current value is 250 mA that approximately corresponds to the maximum output, and the additive amount of the spherical silica microparticles 1 is shown as the mass ratio with the catalyst mass. Although similarly to FIG. 6, there is a large difference in the additive effects of the spherical silica microparticles 1 between the anode and the cathode, if such a difference is excluded, it can be seen from FIG. 7 that the influence that the average particle diameter φ of the spherical silica microparticles 1 has over the maximum output of the fuel cell has a common tendency between the anode and the cathode.

It can be seen from FIG. 7 that the additive amount of the spherical silica microparticles 1 is desirably equal to or less than a mass ratio with the catalyst mass of 0.40, and more preferably equal to or less than 0.30.

Although the invention has been described based on embodiments and applied examples above, various modifications are possible on the examples described above based on the technical idea of the invention. Since the materials or the shapes of the microparticles that are added or the presence or absence of surface pores is not relevant, it is possible to use microparticles that are inexpensive to obtain industrially, and it is possible to obtain an intrinsic performance with little appreciation in costs. Further, since the type or the form of the catalyst is not relevant, adoption for a variety of uses and conditions is possible. There are no limitations with regard to the electrolyte material either, and adoption for a variety of uses and conditions is possible.

### INDUSTRIAL APPLICABILITY

The polymer electrolyte-catalyst composite structure particles of the invention are effective in increasing the efficiency of electrode media, and electrodes, membrane electrode assemblies (MEA), and electrochemical devices produced using the polymer electrolyte-catalyst composite particles are able to be applied to fuel cells, and are able to contribute to the widespread adoption of fuel cells such as DMFCs.

### REFERENCE SIGNS LIST

1 MICROPARTICLE
2 ION CONDUCTING POLYMER ELECTROLYTE LAYER
3 CATALYST PARTICLES WITH ELECTRON CONDUCTIVITY
4 POLYMER ELECTROLYTE-CATALYST COMPOSITE STRUCTURE PARTICLE
5 ION PATHWAY
6 ELECTRON PATHWAY
7 CONTACT POINT
8 VACANCY
10 FUEL CELL
11 HYDROGEN ION(PROTON)CONDUCTING POLYMER ELECTROLYTE MEMBRANE
12 ANODE (NEGATIVE ELECTRODE; FUEL ELECTRODE)
12a GAS PERMEABLE POWER COLLECTOR (GAS DIFFUSION LAYER)
12b ANODE CATALYST LAYER
13 CATHODE (POSITIVE ELECTRODE; OXYGEN ELECTRODE)
13a GAS PERMEABLE POWER COLLECTOR (GAS DIFFUSION LAYER)
13b CATHODE CATALYST LAYER
14 MEMBRANE ELECTRODE ASSEMBLY (MEA)
15 ANODE TERMINAL
16 CATHODE TERMINAL
17 EXTERNAL CIRCUIT
21 FUEL FLOW PATH
22 FUEL INTRODUCTION OPENING
23 FUEL DISCHARGE OPENING
24 OXYGEN (AIR) FLOW PATH
25 OXYGEN (AIR) INTRODUCTION OPENING
26 OXYGEN (AIR) DISCHARGE OPENING
51 POLYMER ELECTROLYTE PARTICLE
52 CATALYST PARTICLE
53 VACANCY
54 MICROPARTICLE
10 FUEL CELL
101 PLATINUM SUPPORTING CARBON PARTICLE
101a CARBON PARTICLE
101b PLATINUM PARTICLE
102 Nafion® COATED SILICA PARTICLE
102a SILICA PARTICLE
102b Nafion®
111 HYDROGEN ION(PROTON)CONDUCTING POLYMER ELECTROLYTE MEMBRANE
112 GAS PERMEABLE POWER COLLECTOR (GAS DIFFUSION LAYER)
113 CATALYST LAYER
200 POLYMER ELECTROLYTE-CATALYST COMPLEX
201 CARBON PARTICLE
202 HYDROGEN ION(PROTON)CONDUCTING POLYMER
203 HYDROGEN ION(PROTON)CONDUCTION PATH
204 HYDROGEN ION(PROTON)CONDUCTING POLYMER FRAME UNIT
205 CATALYST PARTICLE
206 INEFFECTIVE CATALYST PARTICLE

1. A polymer electrolyte-catalyst composite structure particle comprising:
a microparticle;
an ion conducting polymer electrolyte-containing layer that coats a portion or the entirety of a surface of the microparticle and which does not contain a catalyst material; and
a catalyst particle with electron conductivity that is arranged in contact with the polymer electrolyte-containing layer.

2. The polymer electrolyte-catalyst composite structure particle according to claim 1,
wherein the ion conducting polymer electrolyte-containing layer is a polymer electrolyte layer with hydrogen ion (proton) conductivity.

3. The polymer electrolyte-catalyst composite structure particle according to claim 2,
wherein the material of the polymer electrolyte layer with hydrogen ion conductivity is a perfluorosulfonic acid-based resin.

4. The polymer electrolyte-catalyst composite structure particle according to claim 1,
wherein the material of the microparticle is an oxide of silicon or a metallic element, or a conductive carbon material.

5. The polymer electrolyte-catalyst composite structure particle according to claim 1,
wherein a particle diameter φ of the microparticle is 10 nm≦φ≦1 μm.

6. The polymer electrolyte-catalyst composite structure particle according to claim 4,
wherein an additive amount of the silicon oxide (silica) microparticle has a mass ratio to the catalyst mass of equal to or less than 0.40.

7. The polymer electrolyte-catalyst composite structure particle according to claim 1,
wherein the catalyst particle with electron conductivity is a metallic catalyst particle, or a metallic catalyst or a non-metallic catalyst that is supported by a conductive supporting particle.

8. The polymer electrolyte-catalyst composite structure particle according to claim 7,
wherein the catalyst particle with electron conductivity is a platinum catalyst or a platinum ruthenium alloy catalyst that is not supported or is supported by a conductive carbon particle.

9. A manufacturing method of a polymer electrolyte-catalyst composite structure particle comprising:
a first step of mixing a dispersion liquid in which an ion conducting polymer electrolyte material is dispersed and a powder of a microparticle or a dispersion liquid thereof, and coating a portion or the entirety of a surface of the microparticle with an ion conducting polymer electrolyte-containing layer that does not contain a catalyst material;
a second step of adding and mixing a powder of a catalyst particle with electron conductivity or a dispersion liquid thereof to a dispersion liquid obtained in the first step, and arranging the catalyst particle to be in contact with the polymer electrolyte-containing layer.

10. The manufacturing method of a polymer electrolyte-catalyst composite structure particle according to claim 9 comprising:
a step of evaporating a solvent from the dispersion liquid that contains the polymer electrolyte-catalyst composite particle obtained in the second step, and solidifying the polymer electrolyte-catalyst composite particle.

11. An electrode comprising:
a power collector; and
a porous catalyst layer with ion conductivity that is formed in contact with the power collector and which contains a polymer electrolyte-catalyst composite structure particle according to any one of claims 1 to 8.

12. The electrode according to claim 11,
wherein the power collector is gas permeable and the porous catalyst layer has hydrogen ion conductivity.

13. A membrane electrode assembly (MEA) comprising:
a first electrode;
a second electrode; and
an ion conducting electrolyte membrane that is interposed between the first electrode and the second electrode,
wherein at least one of the first electrode and the second electrode is an electrode that includes
a power collector and
a porous catalyst layer with ion conductivity that is formed in contact with the power collector and which contains a polymer electrolyte-catalyst composite particle according to any one of claims 1 to 8.

14. The membrane electrode assembly according to claim 13,
wherein the electrode is an electrode in which the power collector is gas permeable and the porous catalyst layer has hydrogen ion conductivity.

15. An electrochemical device comprising:
a first electrode;
a second electrode; and
an ion conductor that is interposed between the first electrode and the second electrode,
wherein the ion conductor is configured to conduct ions from the first electrode to the second electrode and at least one of the first electrode and the second electrode is an electrode that includes
a power collector and
a porous catalyst layer with ion conductivity that is formed in contact with the power collector and which contains a polymer electrolyte-catalyst composite particle according to any one of claims 1 to 8.

16. The electrochemical device according to claim 15,
wherein the electrode is an electrode in which the power collector is gas permeable and the porous catalyst layer has hydrogen ion conductivity.

17. The electrochemical device according to claim 16 which is configured as a fuel cell.
